(19) United States
(12) Patent Application Publication
(10) Pub. No.: US 2026/0088626 A1
(43) Pub. Date: Mar. 26, 2026

(54) METHOD AND SYSTEM FOR DRIVETRAIN LOAD MITIGATION OF GRID-FORMING DOUBLY-FED INDUCTION GENERATOR-BASED WIND TURBINE GENERATORS BASED ON PHASE ANGLE FEEDFORWARD

(71) Applicant: SHANDONG UNIVERSITY, Jinan (CN)

(72) Inventors: Lei DING, Jinan (CN); Zhihao WANG, Jinan (CN); Xiaotian YANG, Jinan (CN); You YING, Jinan (CN)

(21) Appl. No.: 19/333,487

(22) Filed: Sep. 19, 2025

(30) Foreign Application Priority Data
Sep. 20, 2024 (CN) 202411318606X

(51) Int. Cl. H02J 3/38; F03D 7/02; H02P 9/00; H02P 9/02; H02P 9/10

(52) U.S. Cl. CPC H02J 3/38; F03D 7/0298; H02P 9/007; H02P 9/02; H02P 9/105; F05B 2260/964; H02J 2101/28

(57) ABSTRACT

A method for drivetrain load mitigation of grid-forming (GFM) doubly-fed induction generator (DFIG)-based wind turbine generator (WTG) based on phase angle feedforward, wherein: acquiring active power of a GFM DFIG-based WTG; calculating difference value between acquired active power of GFM DFIG-based WTG and active power reference value; inputting difference value into GFM control to obtain output signal; adding output signal and reference frequency value of virtual synchronous coordinate system to obtain frequency of virtual synchronous coordinate system; integrating the frequency to obtain output value; multiplying additional damping active power reference value of GFM DFIG-based WTG by control gain of phase angle feedforward control to obtain product result; adding product result and output value to obtain angle of virtual synchronous coordinate system, and based on the angle, obtaining control quantity for generator output voltage phase; based on control quantity, adjusting phase of actual output voltage of GFM DFIG-based WTG by controlling rotor excitation current.

### CROSS-REFERENCE TO RELATED APPLICATIONS

The present application claims the priority of Chinese Patent Application No. 202411318606.X filed to China National Intellectual Property Administration on Sep. 20, 2024, and entitled “METHOD AND SYSTEM FOR DRIVETRAIN DAMPING ENHANCEMENT OF GRID-FORMING DOUBLY-FED INDUCTION GENERATOR-BASED WIND TURBINE GENERATOR BASED ON PHASE ANGLE FEEDFORWARD”, the entire content of which is incorporated by reference in the present application to constitute a part of the present invention for all objectives.

### TECHNICAL FIELD

The present invention belongs to the technical field of doubly-fed induction generator-based wind turbine control, and in particular to a method and system for drivetrain load mitigation of grid-forming (GFM) doubly-fed induction generator (DFIG)-based wind turbine generators (WTGs) based on phase angle feedforward.

### BACKGROUND

The statements in this section merely provide background art information related to the present invention and do not necessarily constitute the prior art.

Against the backdrop of global energy shortages and increasingly serious environmental issues, wind power generation, as a clean and renewable energy source, has gradually become an important component of modern power systems. Due to lower energy conversion costs and higher power generation efficiency, the DFIG sets occupy a significant position in the global wind power market and have been widely applied in wind power generation systems.

The DFIG-based wind turbine generator (WTG) set is a kind of complex energy conversion system involving wind energy, mechanical energy, and electrical energy. Ensuring the safety of the generator set both at the electrical and mechanical levels is not only crucial to guarantee the stable operation and long-term reliability of the system, but also improves power generation efficiency, reduces downtime and maintenance costs, thus meeting the requirements for safety and environmental protection.

GFM DFIG-based WTG sets are an emerging technology that is gradually being demonstrated and applied in the wind power industry. GFM technology enables WTG sets to provide support for grid voltage and frequency during grid connection, thereby improving the safety and stability of system operation. However, the existing GFM control technologies are mainly focused on improving the grid connection characteristics of WTG sets, while neglecting the optimization of the internal mechanical stability of the WTG sets.

Specifically, during generator operation, due to insufficient inherent damping in the drivetrain, the gearbox is easy to bear a relatively large extent of torque fluctuations, which thus threaten system safety and reliability. To address this, virtual damping is typically introduced in operational control to enhance drivetrain damping by simulating the effect of physical damping, thereby ensuring stable operation of the generator set.

However, in GFM WTG sets, the response of the active power output value to the active power reference value exhibits a significant delay, leading to a substantial weakening in the effect of virtual damping control, thus making it difficult to achieve the same control effect as when applied to the DFM WTG sets. Meanwhile, there exists a coupling correlation between the active power response and GFM capability of the DFIG-based WTG sets, and the existing control methods are hardly to simultaneously optimize both the active power response speed and GFM capability under weak grid conditions.

### SUMMARY

To overcome the above defects in the prior art, the present invention provides a method for drivetrain load mitigation of GFM DFIG-based WTGs based on phase angle feedforward, which effectively reduces the active power response delay, enhances the effect of virtual damping control under weak grid conditions, and is free of affecting the GFM capability of the DFIG-based WTGs.

To achieve the above objective, one or more embodiments of the present invention provide the following technical solutions:

In a first aspect, disclosed is a method for drivetrain load mitigation of GFM DFIG-based WTGs based on phase angle feedforward, including:
acquiring an active power of a GFM DFIG-based WTG;
calculating a difference value between the acquired active power of the GFM DFIG-based WTG and an active power reference value, and then inputting the difference value into a GFM control to obtain an output signal;
adding the output signal and a reference frequency value of a virtual synchronous coordinate system to obtain a frequency of the virtual synchronous coordinate system;
integrating the frequency of the virtual synchronous coordinate system to obtain an output value;
multiplying an additional damping active power reference value of the GFM DFIG-based WTG by a control gain of phase angle feedforward control to obtain a product result;
adding the product result and the output value to obtain an angle of the virtual synchronous coordinate system, and based on the angle, obtaining a control quantity for an output voltage phase of the generator;
based on the control quantity, obtaining a pulse width modulation (PWM) signal of a converter of the GFM DFIG-based WTG, and controlling a switching state (on/off) of a switching tube for the converter of the GFM DFIG-based WTG using the PWM signal, thus controlling a rotor excitation current of the GFM DFIG-based WTG, adjusting a phase of an actual output voltage of the GFM DFIG-based WTG, causing a change in the output active power of the GFM DFIG-based WTG, and ultimately transferring a fault energy that triggers torsional vibration on the drivetrain, thereby achieving mitigation of the drivetrain load.

As a further technical solution, the angle of the virtual synchronous coordinate system may be expressed as:

$${\overbrace{{θ}_{U} = \int {f}_{GFM} dt}}^{Conventional control method}$$

$$⇓$$

$${\underbrace{{θ}_{U} = \int {f}_{GFM} dt + {K}_{PFF} {P}_{damp \_ ref}}}_{Control scheme of the present invention}$$

wherein, K_{PFF} is the control gain of the phase angle feedforward control, P_{damp_ref} is the additional damping active power reference value, f_{GFM} is the frequency of the virtual synchronous coordinate system, and θ_{U} is a phase of an output voltage of the GFM DFIG-based WTG.

As a further technical solution, the transfer function of the method is:

$$Δ P ( s ) = \frac{G ( s ) H ( s ) + {K}_{PFF} H ( s )}{1 + G ( s ) H ( s )} Δ {P}_{ref} ( s ) ,$$

$$Δ {θ}_{U} ( s ) = \frac{G ( s ) H ( s )}{1 + G ( s ) H ( s )} Δ {θ}_{E} ( s ) ;$$

wherein, G(s) is a feedforward control transfer function in active power control for phase adjustment, and H(s) is a feedback response transfer function in the active power control for phase adjustment.

In a second aspect, disclosed is a system for drivetrain load mitigation of GFM DFIG-based WTGs based on phase angle feedforward, including:
an active power acquisition module, configured to: acquire an active power of a GFM DFIG-based WTG;
a controller processing module, configured to: calculate a difference value between the acquired active power of the GFM DFIG-based WTG and an active power reference value, and then to input the difference value into a GFM control to obtain an output signal;
adding the output signal and a reference frequency value of a virtual synchronous coordinate system to obtain a frequency of the virtual synchronous coordinate system;
integrating the frequency of the virtual synchronous coordinate system to obtain an output value;
multiplying an additional damping active power reference value of the GFM DFIG-based WTG by a control gain of phase angle feedforward control to obtain a product result;
adding the product result and the output value to obtain an angle of the virtual synchronous coordinate system, and based on the angle, obtaining a control quantity for a generator output voltage phase;
a control module, configured to: obtain a PWM signal of a converter of the GFM DFIG-based WTG based on the control quantity, and control a switching state (on/off) of a switching tube for the converter of the GFM DFIG-based WTG using the PWM signal, thus controlling a rotor excitation current of the GFM DFIG-based WTG, adjust a phase of an actual output voltage of the GFM DFIG-based WTG to cause a change in the output active power of the GFM DFIG-based WTG, and ultimately transfer a fault energy that triggers torsional vibration on the drivetrain, thereby achieving mitigation of the drivetrain load.

One or more of the above technical solutions have the following beneficial effects:

The technical solution of the present invention is to directly feed forward the active power reference value of the GF-DFWTG into the phase angle, thereby avoiding the phase adjustment process dominated by an integral component. The active power response speed is accelerated.

According to the technical solution of the present invention, an asymmetric control structure is adopted as the overall controller to break the coupling between the active power response and GFM capability. On the basis of not affecting the GFM capability of the WTG set, the active power response delay is effectively reduced, and the effect of virtual damping control is improved under weak grid conditions.

The advantages of the additional aspects in the present invention will be partially given in the description below, and part of them will become obvious from the description below or will be learned from the practice of the present invention.

### BRIEF DESCRIPTION OF THE DRAWINGS

Drawings attached to the description that constitute a part of the present invention are used to provide further understanding of the present invention. Schematic embodiments of the present invention and specification thereof are used to interpret the present invention and are free of constituting improper limitations to the present invention.

FIG. 1 is a schematic diagram showing characteristic values corresponding to characteristic equations under different grid strengths;

FIG. 2 is a block diagram showing a conventional control structure;

FIG. 3 is a block diagram showing a control structure according to an embodiment of the present invention;

FIG. 4 is a diagram showing characteristic values corresponding to characteristic equations under different grid intensities after adopting phase angle feedforward control according to an embodiment of the present invention;

FIG. 5 is a block diagram showing specific control implementation of a conventional control scheme;

FIG. 6 is a block diagram showing specific control implementation of a control scheme according to an embodiment of the present invention;

FIG. 7 is a schematic diagram showing emulation conditions of an emulation case I according to the present invention;

FIG. 8A is a schematic diagram showing GFM capability analysis on a conventional control structure;

FIG. 8B is a schematic diagram showing GFM capability analysis on a control structure according to an embodiment of the present invention;

FIG. 9 is a schematic diagram showing emulation conditions of an emulation case II according to the present invention;

FIG. 10A is a schematic diagram showing active power response delay analysis on a conventional control structure;

FIG. 10B is a schematic diagram showing active power response delay analysis on the control structure according to an embodiment of the present invention; and

FIG. 11 is a block diagram showing a closed-loop transfer function of a drivetrain of a GFM DFIG-based WTG according to an embodiment of the present invention.

### DETAILED DESCRIPTION

It should be noted that the following detailed description is exemplary and is intended to provide further explanation of the present invention. Unless otherwise specified, all technical terms and scientific terms used herein have the same meanings as commonly understood by those skilled in the art to which the present invention belongs.

It should be noted that the terms used herein are only for describing specific embodiments and are not intended to limit the exemplary embodiments according to the present invention.

In the case of no conflict, the embodiments and the features in the embodiments of the present invention can be combined with each other.

### Example 1

A dual-mass model is used to illustrate that the effect of virtual damping control in a GFM DFIG-based WTG set will be weakened under weak grid conditions.

The dual-mass model may accurately reflect the torsional dynamic characteristics of a drivetrain, and its motion equations are as follows:

$${J}_{t} {\dot{ω}}_{t} = {T}_{t} - {T}_{s} \qquad ( 1 )$$

$${J}_{g} {\dot{ω}}_{g} = {T}_{s} - {T}_{g}$$

$${\dot{θ}}_{g} = {ω}_{g}$$

$${\dot{θ}}_{t} = {ω}_{t}$$

$${T}_{s} = {K}_{s} ( {θ}_{t} - {θ}_{g} ) + {D}_{s} ( {ω}_{t} - {ω}_{g} ) \qquad ( 2 )$$

wherein, Jₜ, J_{g}, ωₜ, ω_{g}, θₜ, and θ_{g} represent a rotational inertia, an angular velocity, and an angle of a wind turbine and a generator, respectively; Tₜ, T_{g}, and Tₛ represent an aerodynamic torque, an electromagnetic torque, and a shaft torque, respectively; Kₛ and Dₛ represent an equivalent stiffness and equivalent damping of a drive shaft, respectively.

The block diagram of the closed-loop transfer function of the drivetrain of the GFM DFIG-based WTG is shown in FIG. 11. In the present example, the characteristic equation of the system closed-loop transfer function is first derived, where “Δ” denotes a linearized model of each quantity.

Substituting the Equation (2) into the Equation (1) to yield:

$$Δ {ω}_{g} = - {G}_{shaft} ( s ) Δ {T}_{g} \qquad ( 3 )$$

$$wherein ,$$

$${G}_{shaft} ( s ) = \frac{{J}_{t} {s}^{2} + {D}_{s} s + {K}_{s}}{{J}_{t} {J}_{g} {s}^{3} + ( {J}_{t} + {J}_{g} ) {D}_{s} {s}^{2} + ( {J}_{t} + {J}_{g} ) {K}_{s}} \qquad ( 4 )$$

wherein, G_{shaft}(s) represents the transfer function corresponding to the drivetrain block in FIG. 11.

$$Δ {T}_{g} = {G}_{damp \_ 1} ( s ) Δ {ω}_{g} \qquad ( 5 )$$

In the present application, the transfer function G_{damp_1}(s) may be obtained through the following process:

In the prior art, the converter of the GFM DFIG-based WTG is typically controlled using power, and there exists a relational expression among an output active power, an electromagnetic torque and an angular velocity of the generator as follows:

$$P = {ω}_{g} {T}_{g} \qquad ( 6 )$$

The output active power of the GFM DFIG-based WTG may be further expressed as:

$$P = \frac{EU}{X} sin ( {θ}_{U} - {θ}_{E} ) \qquad ( 7 )$$

wherein, E, U, θ_{E}, θ_{U} represent magnitudes and phase angles of an external grid voltage and internal voltage, respectively. X is an equivalent impedance between the Point of Common Coupling (PCC) and the external grid.

The present example is mainly focused on the active power and phase issues, so the dynamic variation of the voltage magnitude is ignored, i.e., its reference value is assumed to be constant. Then, the dynamics of the phase angle of the internal voltage may be approximated by a first-order inertial component:

$${θ}_{U} = \frac{1}{{T}_{VC} s + 1} {θ}_{dq} \qquad ( 8 )$$

wherein, T_{VC} is an equivalent time constant of voltage control; s is a Laplace operator.

Further, assuming the external voltage is constant, the Equation (7) may be linearized as:

$$Δ P = \frac{EU}{X} cos ( {θ}_{U 0} - {θ}_{E 0} ) Δ {θ}_{U} \qquad ( 9 )$$

wherein, θ_{EO} and θ_{U0} are a phase angle of the output voltage of the GFM DFIG-based WTG and a phase angle of the grid voltage corresponding to a linearized operating point, respectively.

Since the active power will track the power reference value, the above equations may be further linearized to obtain a relationship from ΔP_{ref} to ΔP as follows:

$$Δ P = {G}_{GFM \_ 1} ( s ) Δ {P}_{ref} \qquad ( 10 )$$

$${G}_{GFM \_ 1} ( s ) = \frac{{K}_{p}}{{T}_{VC} {As}^{2} + As + {K}_{p}} \qquad ( 11 )$$

$$A = \frac{X}{EU cos ( {θ}_{U 0} - {θ}_{E 0} )}$$

Considering virtual damping control, the active power reference value of the GFM DFIG-based WTG may be expressed as:

$${P}_{ref} = {P}_{MPPT \_ ref} + {P}_{damp \_ ref} \qquad ( 12 )$$

wherein, P_{MPPT_ref} is an active power reference value generated by a maximum power point tracking (MPPT) controller; P_{damp_ref} is an additional damping active power reference value generated by damping control, P_{damp_ref}=ω_{g}T_{damp}.

In the present example, considering that P_{MPPT_ref} is slower than a time scale corresponding to the vibration problem of the drivetrain described in the present application, a first-order inertial component is thus used to approximate its control dynamics. Therefore, P_{MPPT_ref} is linearized as:

$$Δ {P}_{MPPT \_ ref} = \frac{1}{{T}_{MPPT} s + 1} {K}_{MPPT} {ω}_{g 0} {Δω}_{g} \qquad ( 13 )$$

wherein, K_{MPPT} and T_{MPPT} are an equivalent control gain and a time constant of MPPT control, respectively.

By combining equations (4), (12), and (13), it may be obtained:

$$Δ {P}_{ref} = [ \frac{{K}_{MPPT}}{{T}_{MPPT} s + 1} + {K}_{damp} {G}_{BPF} ( s ) ] {ω}_{g 0} {Δω}_{g} \qquad ( 14 )$$

Furthermore, according to the Equation (7), the additional torque equation may be derived as:

$$Δ {T}_{g} = \frac{1}{{ω}_{g 0}} Δ P - \frac{{T}_{g 0}}{{ω}_{g 0}} {Δω}_{g} \qquad ( 15 )$$

It follows that:

$$Δ {T}_{g} = {G}_{damp \_ 1} ( s ) {Δω}_{g} \qquad ( 16 )$$

$${G}_{damp \_ 1} ( s ) = {\underbrace{{K}_{damp} {G}_{GFM \_ 1} ( s ) {G}_{BPF} ( s )}}_{Virtual damping control} - \frac{{T}_{g 0}}{{ω}_{g 0}} + \frac{{K}_{MPPT}}{{T}_{MPPT} s + 1} \qquad ( 17 )$$

$$wherein , \frac{{K}_{MPPT}}{{T}_{MPPT} s + 1}$$

corresponds to a Speed Control block in FIG. 11, K_{damp}G_{BPF}(s) corresponds to a Damping control block in FIG. 11, G_{GFM_1}(s) corresponds to an Active power response block in FIG. 11, and

$$- \frac{{T}_{g 0}}{{ω}_{g 0}}$$

corresponds to a block of the same name.

Further, the characteristic equation of the closed-loop characteristics of the drivetrain system can be expressed as:

$$1 + {G}_{shaft} ( s ) {G}_{damp \_ 1} ( s ) = 0 \qquad ( 18 )$$

The characteristic values corresponding to characteristic equations under different grid strengths are shown in FIG. 1. As can be seen, the under-damping modality of the system is controlled by a pair of conjugate characteristic values, corresponding to the shafting vibration of the drivetrain. As the grid strength decreases, the real part of the characteristic value gradually increases from −1.8 to −0.26, the effect of virtual damping control is weakened, resulting in deteriorated stability of the drivetrain system.

An analysis on the coupling between the GFM control and active power response in the GFM DFIG-based WTG is performed in the technical solution of the example:

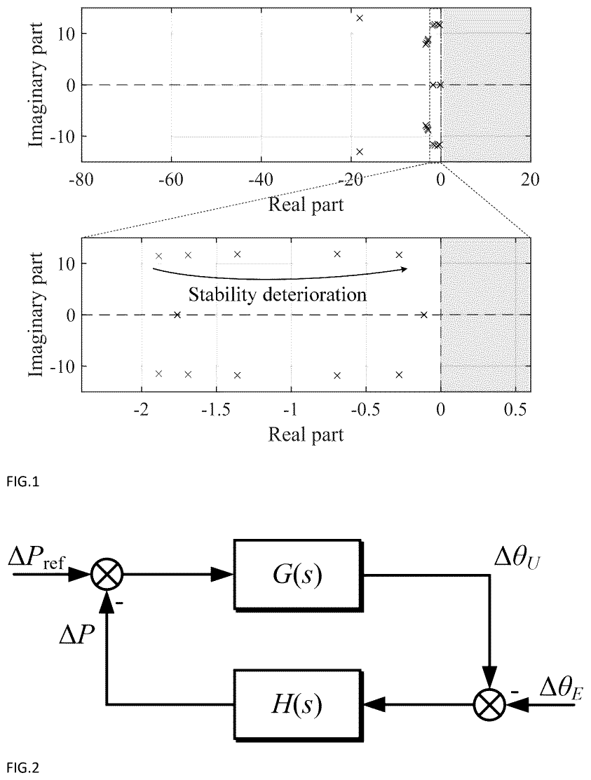

The GFM capability refers to the ability of GFM DFIG-based WTG to keep the magnitude and phase of internal voltage almost unchanged in case of occurring external grid disturbances. This patent is focused on the ability of the GFM DFIG-based WTG to maintain an almost unchanged internal voltage phase. FIG. 2 is a block diagram of phase-adjustment active power control. A nonlinear system is linearized at a grid connection point.

A transfer function from ΔP_{ref}(s) to ΔP(s), and a transfer function from Δθ_{E} to Δθ_{U} may be obtained as:

$$Δ P ( s ) = \frac{G ( s ) H ( s )}{1 + G ( s ) H ( s )} Δ {P}_{ref} ( s ) \qquad ( 19 )$$

$${Δθ}_{U} ( s ) = \frac{G ( s ) H ( s )}{1 + G ( s ) H ( s )} {Δθ}_{E} ( s )$$

$${\underbrace{\frac{Δ P ( s )}{Δ {P}_{ref} ( s )}}}_{Active power response} = {\underbrace{\frac{{Δθ}_{U} ( s )}{{Δθ}_{E} ( s )}}}_{Grid - forming capability} \qquad ( 20 )$$

wherein, P and P_{ref} are the active power and the active power reference value, respectively; θ_{E} and θ_{U} are the grid voltage phase and the phase of the output voltage of the GFM DFIG-based WTG, respectively. Plus “Δ” denotes an incremental model of each quantity. The transfer functions ΔP(s)/ΔP_{ref}(s) and Δθ_{U}/Δθ_{E} are the same; the former represents a desired fast response speed of active power, while the latter represents a desired slow response speed of GFM capability. However, any modification to G(s) will simultaneously affect both the active power response characteristics and the GFM capability under a conventional control structure. That is, active power is accelerated. That is, accelerating the active power response will also weaken the GFM capability, i.e., it is not possible to optimize the two simultaneously.

The present example discloses a method for drivetrain load mitigation of a GFM DFIG-based WTG based on phase angle feedforward, including as follows.

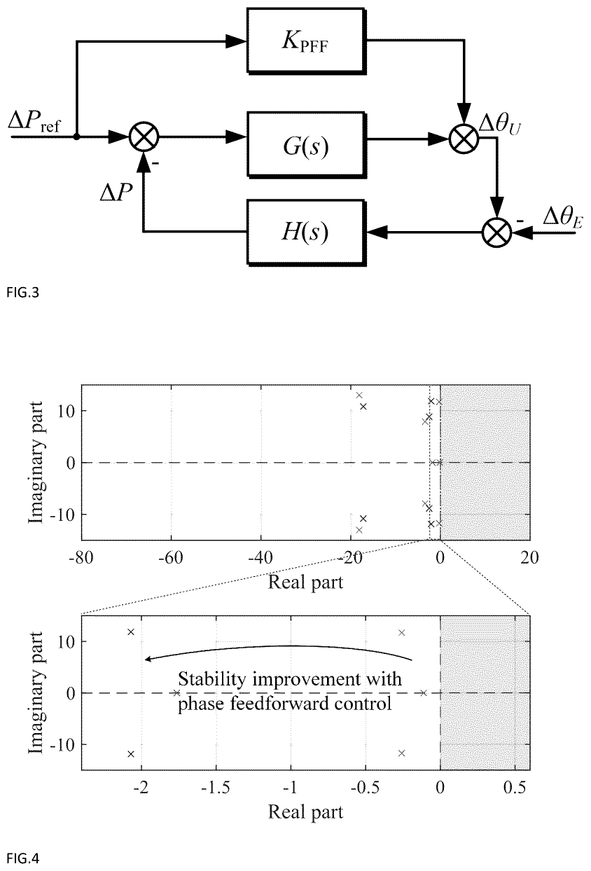

Based on the virtual damping control of the drivetrain of the GFM DFIG-based WTG in the prior art: a band-pass filter (BPF) is used to filter out the synchronous speed in the GFM DFIG-based WTG (i.e., the rotary speed when the GFM DFIG-based WTG is stably grid-connected), and an oscillatory speed (the oscillating component is a low-frequency signal and thus, is easily separated from the synchronous component using a BPF), and then is multiplied by a damping coefficient (K_{damp}) to obtain an additional damping torque (T_{damp}), then further multiplied by the synchronous speed (ω_{g0}, the angular velocity value of the generator at a certain operating point) to obtain the additional damping active power reference valueP_{damp_ref};
the additional damping active power reference value P_{damp_ref} is directly fed forward into the phase angle, avoiding the phase adjustment process dominated by the integral component. The active power response speed is accelerated. The phase angle formula under the virtual synchronous coordinate system is:

$${\overbrace{{θ}_{U} = \int {f}_{GFM} dt}}^{Conventional control method} \qquad ( 21 )$$

$$⇓$$

$${\underbrace{{θ}_{U} = \int {f}_{GFM} dt + {K}_{PFF} {P}_{damp \_ ref}}}_{Control scheme of the present invention}$$

wherein, K_{PFF} is a control gain of the phase angle feedforward control, f_{GFM} is a frequency of the virtual synchronous coordinate system; after further adopting the phase angle feedforward scheme, the structural diagram of the phase angle feedforward control is shown in FIG. 3.

As can be seen, in the conventional control structure, the additional damping power reference value (ΔP_{damp_ref}) is placed at P_{ref}, then f_{GFM} is obtained through a power synchronization loop, and finally the output value is obtained by integration. However, based on the conventional control structure, the present patent is to feed forward the additional damping active power reference value to the phase angle to achieve better load mitigation control effect.

The transfer function turns into:

$$Δ P ( s ) = \frac{G ( s ) H ( s ) + {K}_{PFF} H ( s )}{1 + G ( s ) H ( s )} Δ {P}_{ref} ( s ) \qquad ( 22 )$$

$${Δθ}_{U} ( s ) = \frac{G ( s ) H ( s )}{1 + G ( s ) H ( s )} {Δθ}_{E} ( s )$$

By adopting an asymmetric control structure, the coupling between active power response and GFM capability is broken. The active power response delay is effectively reduced, and the effect of virtual damping control under weak grid conditions is improved, and meanwhile the GFM capability of the GFM DFIG-based WTG is not affected.

After further adopting the phase angle feedforward control, the Equation (18) turns into:

$$1 + {G}_{shaft} ( s ) {G}_{damp} ( s ) = 0 \qquad ( 23 )$$

wherein, G_{damp}(s) is the transfer function corresponding to ΔT_{g}=G_{damp}(s)Δω_{g} after utilizing phase angle feedforward.

After adopting the phase angle feedforward control, the characteristic values corresponding to the characteristic equations under different grid strengths are shown in FIG. 4. After applying the proposed control scheme, the real part of the characteristic value decreases from −0.26 to −2.1. The stability of the drivetrain system is significantly improved.

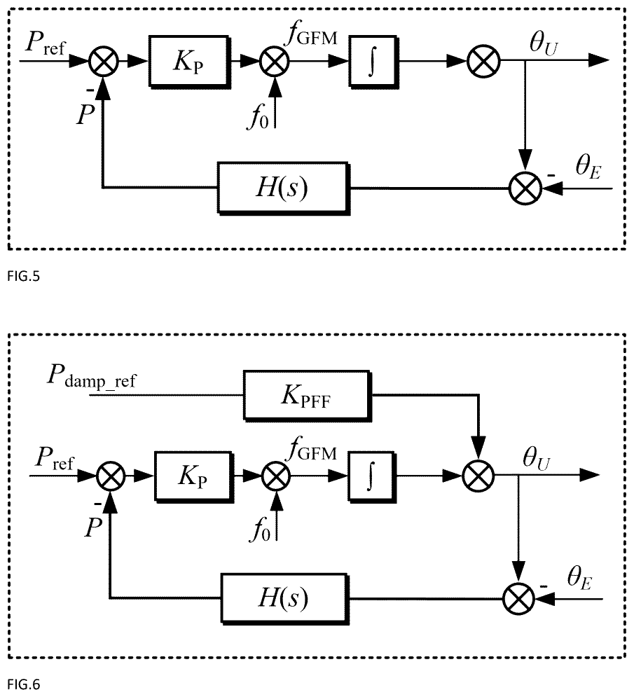

FIG. 5 and FIG. 6 show block diagrams of detailed control implementation of the conventional scheme and the proposed scheme, respectively. As shown in FIG. 6, in the specific control implementation of the proposed scheme, when the grid fluctuates, a difference value between the acquired active power and the active power reference value is calculated and input into a PI controller to obtain an output signal, the output signal is then added to f₀ (a given reference frequency value of the virtual synchronous coordinate system) to obtain f_{GFM} (the frequency of the virtual synchronous coordinate system). Further, after integrating f_{GFM}, an output value is added to a product of P_{damp_ref} and K_{PFF} to obtain θ_{U} (θ_{U} is the phase of the output voltage of the GFM DFIG-based WTG), and further to obtain a control quantity of the phase of the generator output voltage, and then to obtain a PWM signal of a converter of the GFM DFIG-based WTG. The PWM signal is utilized to control a switching status (on/off) for the converter of the switching tube of the GFM DFIG-based WTG, thereby controlling a rotor excitation current of the GFM DFIG-based WTG. A phase of an actual output voltage of the GFM DFIG-based WTG is adjusted, and fault energy triggering torsional vibration on the drivetrain is transferred to power grid, thus completing the mitigation of drivetrain load.

Under the influence of load mitigation control, after the generator phase control quantity is quickly adjusted, the d-axis and q-axis voltage reference values of the generator change firstly, then the d-axis and q-axis current reference values are controlled to change by a voltage control loop, and finally a new PWM signal is obtained through controlling a rotor current loop to control the switching on/off of the switching tube. The switching status (on/off) of the switching tube changes, the rotor excitation current changes, and the phase of the actual output voltage of the GFM DFIG-based WTG changes such that the fault energy in the drivetrain is transferred to the grid, which is equivalent to an increase in the damping coefficient of the drivetrain.

Further, two emulation cases are used to verify the effectiveness of the proposed control structure and system:

Case I: grid frequency drop. It is verified that the GFM capability of the GFM DFIG-based WTG is not affected after the phase angle feedforward control scheme is adopted.

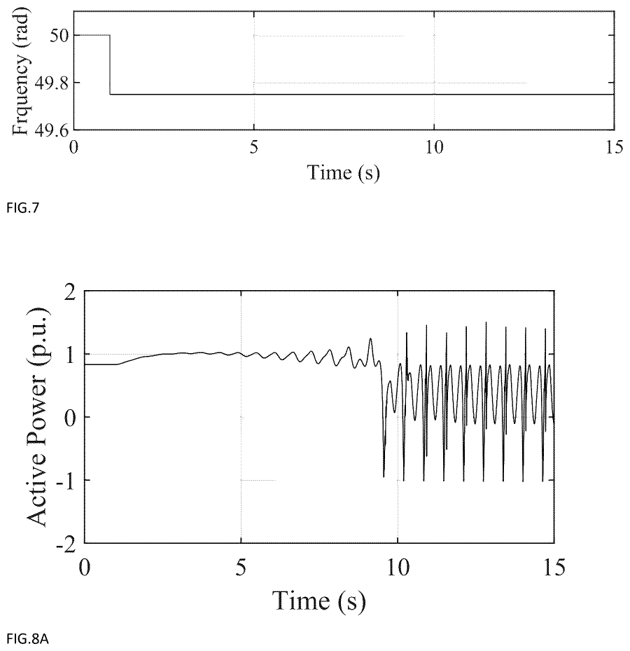

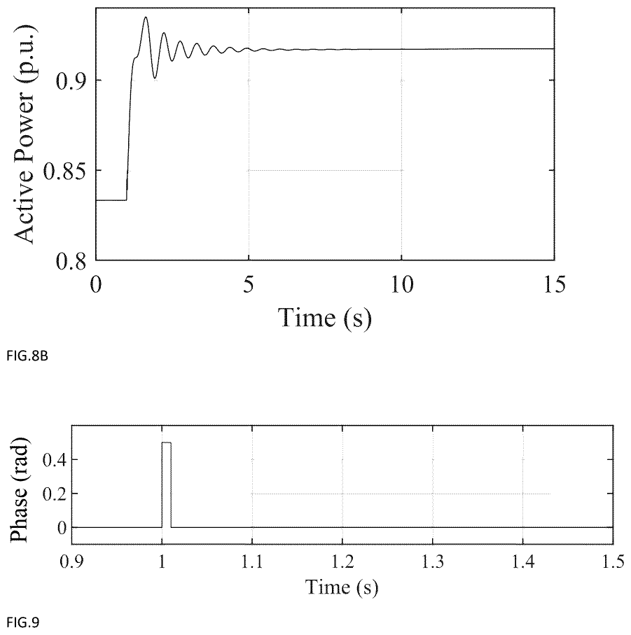

The emulation conditions are shown in FIG. 7. At t=1 s, the external grid frequency drops from 50 Hz to 49.75 Hz. The GFM capability analysis is shown in FIG. 8A and FIG. 8B, where FIG. 8A is a schematic diagram showing GFM capability analysis on a conventional control structure, and FIG. 8B is a schematic diagram showing GFM capability analysis on the proposed control structure.

As can be seen, after frequency drop, both the steady-state active support and the response speed of active support are not affected. Phase angle feedforward control does not affect the frequency support capability of the GFM DFIG-based WTG, that is, the capability to maintain nearly unchanged phase in GFM is preserved.

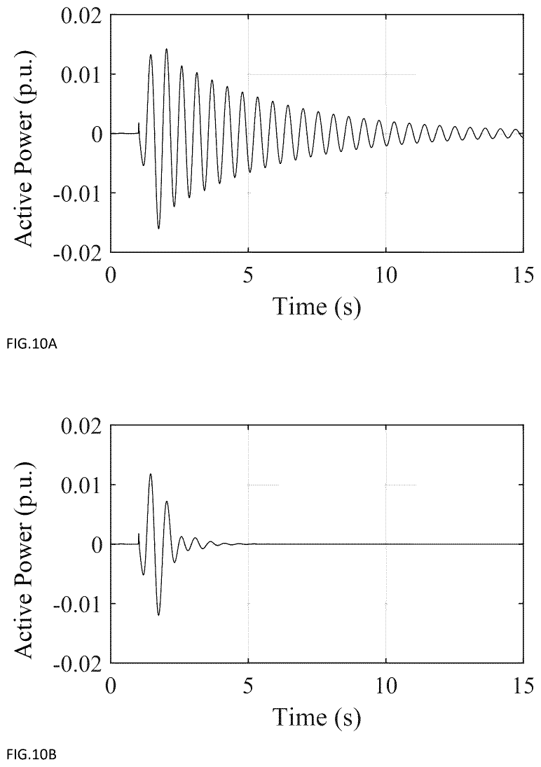

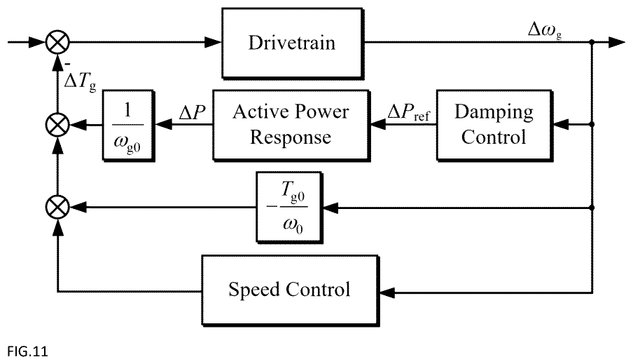

Case II: a phase jump lasting 10 milliseconds is used to excite torsional vibration of the drivetrain. It is verified whether active response delay may be reduced by a phase angle feedforward control scheme to improve the effect of virtual damping control under weak grid conditions. The emulation conditions are shown in FIG. 9. At t=1 s, the external grid voltage phase jumps by 0.5 rad at 1 second and recovers at 1.01 seconds. FIG. 10A is a schematic diagram showing active power response delay analysis on a conventional control structure; and FIG. 10B is a schematic diagram showing active power response delay analysis on the proposed control structure.

As can be seen, under the conventional control structure, the vibration duration of the drivetrain exceeds 10 seconds; while under the proposed control structure, the vibration of the drivetrain is successfully suppressed within 2 seconds. It is verified that the proposed control scheme may improve the effect of virtual damping control of the GFM DFIG-based WTG when connected to a weak grid.

The technical solution of the present example analyzes a coupling mechanism between the GFM control and the active power response. Based on the analysis result of electromechanical coupling characteristics, a phase angle feedforward control method is put forward to break the coupling between the two, thereby improving the effect of virtual damping control under weak grid conditions while maintaining the GFM capability.

Analysis on the coupling between the GFM control and active power response of the GFM DFIG-based WTG.

The GFM capability refers to the ability of the GFM DFIG-based WTG to keep the magnitude and phase of internal voltage almost unchanged in case of occurring external grid disturbances. The present example is focused on the ability of the GFM DFIG-based WTG to maintain an almost unchanged internal voltage phase. A nonlinear system is linearized at a grid connection point.

The technical solution of the present example accelerates the active power response speed of the GFM DFIG-based WTG to be connected to a weak grid, optimizes the dynamic response performance of the GFM DFIG-based WTG, and improves the effect of virtual damping control.

An asymmetric control structure is adopted in the technical solution of the present example, breaking the coupling between active power response and GFM capability. The active response delay of the GFM DFIG-based WTG is reduced; meanwhile, it is ensured that the steady-state active support and the response speed of active support are almost unaffected after frequency drop, thus maintaining the GFM capability of the GFM DFIG-based WTG.

### Example II

An objective of the present example is to provide a computer device, including a memory, a processor, and a computer program stored on the memory and executable on the processor; wherein, when the processor executes the computer program, causing the processor to implement steps of the method described above.

### Example III

An objective of the present example is to provide a computer-readable storage medium.

A computer-readable storage medium, having a computer program stored thereon; wherein, when the computer program is executed by a processor, causing the processor to implement steps of the method described above.

### Example IV

An objective of the present example is to provide a system for drivetrain load mitigation of GFM DFIG-based WTGs based on phase angle feedforward, including:
an active power acquisition module, configured to acquire an active power of a GFM DFIG-based WTG set;
a controller processing module, configured to: calculate a difference value between the acquired active power of the GFM DFIG-based WTG set and an active power reference value, and then to input the difference value into a GFM control to obtain an output signal;
adding the output signal and a reference frequency value of a virtual synchronous coordinate system to obtain a frequency of the virtual synchronous coordinate system;
integrating the frequency of the virtual synchronous coordinate system to obtain an output value;
multiplying an additional damping active power reference value of the GFM DFIG-based WTG by a control gain of phase angle feedforward control to obtain a product result;
adding the product result and the output value to obtain an angle of the virtual synchronous coordinate system, and based on the angle, obtaining a control quantity for a phase generator output voltage;
a control module, configured to: obtain a PWM signal of a converter of the GFM DFIG-based WTG based on the control quantity, and control a switching state (on/off) of a switching tube for the converter of the GFM DFIG-based WTG using the PWM signal, thus controlling a rotor excitation current of the GFM DFIG-based WTG, adjust a phase of an actual output voltage of the GFM DFIG-based WTG to cause a change in the output active power of the GFM DFIG-based WTG, and ultimately transfer a fault energy that triggers torsional vibration on the drivetrain, thereby achieving mitigation of the drivetrain load.

### Example V

An objective of the present example is to provide a computer program product containing instructions, wherein when the instructions are executed on a computer, the computer program product causes the computer to implement the methods and functions involved in any one of the examples described above.

Each step in the above example corresponds to the method in Example 1, and the specific embodiments may be referring to the related specification part of Example 1. The term “computer-readable storage medium” should be understood to be “non-transitory” and as including a single medium or multiple media that contain one or more instruction sets. It should also be understood as including any medium that is capable of storing, encoding, or carrying an instruction set for execution by a processor and enabling the processor to execute any method of the present invention.

Those skilled in the art should understand that the modules or steps of the present invention described above can be implemented by a general-purpose computer device. Optionally, they can be implemented by program codes executable by a computing device. Thus, they can be stored in a storage device and executed by the computing device, or they can be separately fabricated into individual integrated circuit modules, or multiple modules or steps among them can be fabricated into a single integrated circuit module for implementation. The present invention is not limited to any specific combination of hardware and software.

The detailed embodiments of the present invention have been described in combination with the drawings, but are not construed as limiting the scope of protection of the present invention. Those skilled in the art should understand that, based on the technical solutions of the present invention, various modifications or variations made by those skilled in the art without any inventive efforts shall still fall within the scope of protection of the present invention.

1. A method for drivetrain damping enhancement of a grid-forming (GFM) doubly-fed induction generator (DFIG)-based wind turbine generator (WTG) based on phase angle feedforward, comprising:
acquiring an active power of the GFM DFIG-based WTG;
calculating a difference value between the acquired active power of the GFM DFIG-based WTG and an active power reference value, and then inputting the difference value into a proportional integral (PI) controller to obtain an output signal;
adding the output signal and a reference frequency value of a virtual synchronous coordinate system to obtain a frequency of the virtual synchronous coordinate system;
integrating the frequency of the virtual synchronous coordinate system to obtain an output value;
multiplying the active power reference value of the GFM DFIG-based WTG by a control gain of phase angle feedforward control to obtain a product result;
adding the product result and the output value to obtain an angle of the virtual synchronous coordinate system, and based on the angle, obtaining a control quantity for a generator output voltage phase; and
based on the control quantity, obtaining a pulse width modulation (PWM) signal of a converter for the GFM DFIG-based WTG, utilizing the PWM signal to realize control of the GFM DFIG-based WTG on a switching tube of the converter, thereby ultimately controlling the GFM DFIG-based WTG to complete the drivetrain damping enhancement.

2. The method for the drivetrain damping enhancement of the GFM DFIG-based WTG based on phase angle feedforward according to claim 1, wherein the angle of the virtual synchronous coordinate system is:
$${θ}_{U} = \int {f}_{GFM} dt + {K}_{PFF} {P}_{ref} ;$$
wherein, K_{PFF} is the control gain of phase angle feedforward control, f_{GFM} is the frequency of the virtual synchronous coordinate system, θ_{U} is a phase of an output voltage of the GFM DFIG-based WTG, and P_{ref} is the active power reference value.

3. The method for the drivetrain damping enhancement of the GFM DFIG-based WTG based on phase angle feedforward according to claim 1, wherein a transfer function of the method is:
$$Δ P ( s ) = \frac{G ( s ) H ( s ) + {K}_{PFF} H ( s )}{1 + G ( s ) H ( s )} Δ {P}_{ref} ( s ) ;$$
$${Δθ}_{U} ( s ) = \frac{G ( s ) H ( s )}{1 + G ( s ) H ( s )} {Δθ}_{E} ( s ) ;$$
wherein, ΔP(s) is an increment of the active power, G(s) is a forward transfer function of an active power control block diagram for phase adjustment, H(s) is a backward transfer function of the active power control block diagram for phase adjustment, K_{PFF} is a control gain of phase angle feedforward control, K_{PFF} is an increment of the active power reference value, Δθ_{U}(s) is an increment for the phase of the output voltage of the GFM DFIG-based WTG, and Δθ_{E}(s) is an increment of a grid voltage phase.

4. The method for the drivetrain damping enhancement for the GFM DFIG-based WTG based on phase angle feedforward according to claim 1, wherein the reference frequency value of the virtual synchronous coordinate system is a given value.

5. A system of drivetrain damping enhancement for a grid-forming (GFM) doubly-fed induction generator (DFIG)-based wind turbine generator (WTG) based on phase angle feedforward, comprising:
an active power acquisition module, configured to acquire an active power of the GFM DFIG-based WTG;
a controller processing module, configured to be: calculating a difference value between the acquired active power of the GFM DFIG-based WTG and an active power reference value, and then inputting the difference value into a proportional integral (PI) controller to obtain an output signal;
adding the output signal and a reference frequency value of a virtual synchronous coordinate system to obtain a frequency of the virtual synchronous coordinate system;
integrating the frequency of the virtual synchronous coordinate system to obtain an output value;
multiplying the active power reference value of the GFM DFIG-based WTG by a control gain of phase angle feedforward control to obtain a product result;
adding the product result and the output value to obtain an angle of the virtual synchronous coordinate system, and based on the angle, obtaining a control quantity for a generator output voltage phase; and
a control module, configured to: obtain a pulse width modulation (PWM) signal of a converter for the GFM DFIG-based WTG based on the control quantity, and utilize the PWM signal to realize control of the GFM DFIG-based WTG on a switching tube of the converter, thereby ultimately controlling the GFM DFIG-based WTG to complete the drivetrain damping enhancement.

6. The system for the drivetrain damping enhancement of the GFM DFIG-based WTG based on phase angle feedforward according to claim 5, wherein the angle of the virtual synchronous coordinate system is:
$${θ}_{U} = \int {f}_{GFM} dt + {K}_{PFF} {P}_{ref} ;$$
wherein, K_{PFF} is the control gain of the phase angle feedforward control, f_{GFM} is the frequency of the virtual synchronous coordinate system, θ_{U} is a phase of an output voltage of the GFM DFIG-based WTG, and P_{ref} is the active power reference value.

7. The system for the drivetrain damping enhancement of the GFM DFIG-based WTG based on phase angle feedforward according to claim 5, wherein a transfer function of the system is:
$${θ}_{U} = \int {f}_{GFM} dt + {K}_{PFF} {P}_{ref} ;$$
wherein, K_{PFF} is the control gain of the phase angle feedforward control, f_{GFM} is the frequency of the virtual synchronous coordinate system, θ_{U} is the phase of the output voltage of the GFM DFIG-based WTG, and P_{ref} is the active power reference value.

8. A computer programming product, comprising a computer program, wherein the computer program is executed by a processor to achieve the steps of the method according to claim 1.

9. A computer device, comprising a memory, a processor, and a computer program stored on the memory and capable of operating on the processor, wherein the program is executed by the processor to achieve steps of the method according to claim 1.

10. A computer-readable storage medium, having a computer program stored thereon, wherein when the computer program is executed by a processor, performing steps of the method according to claim 1.
